(19) United States
(12) Patent Application Publication
(10) Pub. No.: US 2014/0057137 A1
(43) Pub. Date: Feb. 27, 2014

(54) BATTERY PACK

(71) Applicant: SAMSUNG SDI CO., LTD., Yongin-si (KR)

(72) Inventor: Hyeok LEE, Yongin-si (KR)

(73) Assignee: SAMSUNG SDI CO., LTD., Yongin-si (KR)

(21) Appl. No.: 13/795,136

(22) Filed: Mar. 12, 2013

(30) Foreign Application Priority Data
Aug. 21, 2012 (KR) 10-2012-0091401

(51) Int. Cl. H01M 2/02; H01M 2/34

(52) U.S. Cl. CPC H01M 2/0202; H01M 2/34
USPC 429/7

(57) ABSTRACT

A battery pack that includes at least one battery, a protective circuit module electrically connected to the battery, a case accommodating the battery and the protective circuit module, and a film-shaped cover covering the case. The battery pack has an edge portion of the cover is welded to a top end of the case.

### CLAIM PRIORITY

This application makes reference to, incorporates the same herein, and claims all benefits accruing under 35 U.S.C. §119 from an application earlier filed in the Korean Intellectual Property Office on 21 Aug. 2012 and there duly assigned Serial No. 10-2012-0091401.

### BACKGROUND OF THE INVENTION

1. Field of the Invention

Aspects of the present invention generally relate to a battery pack.

2. Description of the Related Art

In general, an electronic device, such as a notebook computer, a mini notebook computer, a net-book, a mobile computer, an ultra mobile personal computer (UMPC) or a portable multimedia player (PMP), employs a battery pack in which a plurality of batteries connected in series and/or parallel are used as a portable power supply.

The above information disclosed in this Related Art section is only for enhancement of understanding of the background of the invention and therefore it may contain information that does not form the prior art that is already known to a person of ordinary skill in the art.

### SUMMARY OF THE INVENTION

Exemplary embodiments of the present invention provide a battery pack, which has a reduced thickness, an increased capacity and a reduced manufacturing cost by connecting a cover and a case to each other by welding.

According to an exemplary embodiment of the present invention, a battery pack is provided, including at least one battery, a protective circuit module electrically connected to the battery, a case accommodating the battery and the protective circuit module, and a film-shaped cover covering the case, wherein an edge portion of the cover is welded to a top end of the case.

The cover may include a main plane portion and the edge portion formed around the main plane portion, and the main plane portion may be adhered to a surface of the battery using an adhesive.

The cover may include a main plane portion and the edge portion formed around the main plane portion, and a welded region of the edge portion may be positioned on the same line with the main plane portion.

The case may include polycarbonate (PC) or polycarbonate/acronitrile-butadiene-styrene (PC/ABS).

The cover may include polycarbonate (PC) or polyethyleneterephthalate (PET).

The cover may have a thickness of 0.15 to 0.25 mm.

The case may include a bottom portion on which the battery and the protective circuit module are mounted and a sidewall portion surrounding the battery and the protective circuit module, and the bottom portion may have a thickness of 0.6 to 0.8 mm.

The battery pack may be a built-in battery pack.

According to another embodiment of the present invention, a battery pack is provided, including at least one battery, a protective circuit module electrically connected to the battery, a frame surrounding the battery and a side portion of the protective circuit module, a film-shaped first cover covering a top portion of the frame, and a film-shaped second cover covering a lower portion of the frame, wherein an edge portion of the first cover may be welded to a top end of the frame and an edge portion of the second cover may be welded to a bottom end of the frame.

The first cover may include a first main plane portion and a first edge portion formed around the first main plane portion, the second cover may include a second main plane portion and a second edge portion formed around the second main plane portion, and the first main plane portion and the second main plane portion may be adhered to a surface of the battery using an adhesive, respectively.

The first cover may include a first main plane portion and a first edge portion formed around the first main plane portion, the second cover may include a second main plane portion and a second edge portion formed around the second main plane portion, a welded region of the first edge portion may be positioned on the same line with the first main plane portion, and a welded region of the second edge portion may be positioned on the same line with the second main plane portion.

The frame may include polycarbonate (PC) or polycarbonate/acronitrile-butadiene-styrene (PC/ABS).

The first cover and the second cover may include polycarbonate (PC) or polyethyleneterephthalate (PET).

Each of the first and second covers may have a thickness of 0.15 to 0.25 mm.

The battery pack may be a built-in battery pack.

As described above, according to the embodiments of the present invention, a battery pack may have a reduced thickness, an increased capacity and a reduced manufacturing cost by connecting a cover and a case to each other by welding.

Additional aspects and/or advantages of the invention will be set forth in part in the description which follows and, in part, will be obvious from the description, or may be learned by practice of the invention.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a battery pack according to an embodiment of the present invention;

FIG. 2 is an exploded perspective view of FIG. 1;

FIG. 3 is a cross-sectional view taken along the line I-I′ of FIG. 1;

FIG. 4 is a perspective view of a battery pack according to another embodiment of the present invention;

FIG. 5 is an exploded perspective view of FIG. 4; and

FIG. 6 is a cross-sectional view taken along the line II-II′ of FIG. 4.

### DETAILED DESCRIPTION OF THE INVENTION

Hereinafter, embodiments of the invention will be described in detail with reference to the accompanying drawings such that the invention can be carried out by a person skilled in the art. However, the invention is not limited to the embodiments, but various modifications can be implemented.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A battery pack may include a protective circuit module (PCM) for protecting the batteries from over-charge, over-discharge or over-current. The batteries and the protective circuit module are embedded in the battery pack with a case.

Recently, there is increasing demand for a slimmer battery pack, and in order to cope with the demand, components of the case are formed by molding so as to have very small thicknesses in a thin film type. In this regard, problems, such as molding failure or bending failure, may be caused. In addition, failures may occur in connecting molded products or attaching a label, resulting in greater cost burdens. Accordingly, in a case of a built-in battery pack, an over-issue becomes particularly serious in the thickness specification.

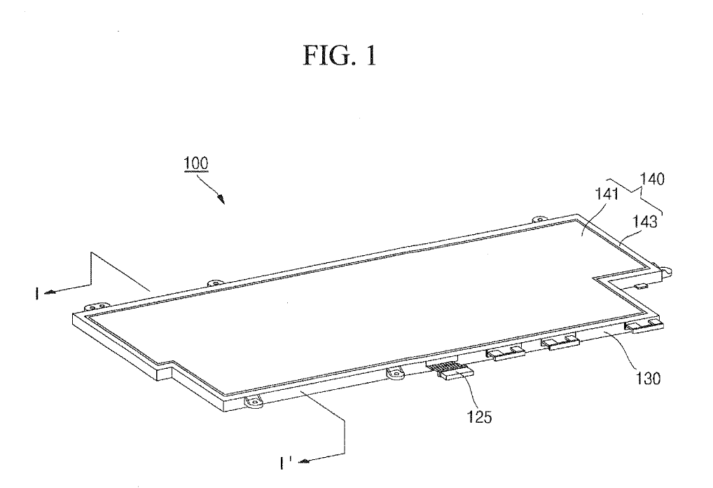

Hereinafter, a battery pack according to an embodiment of the present invention will be described with reference to FIGS. 1 to 3.

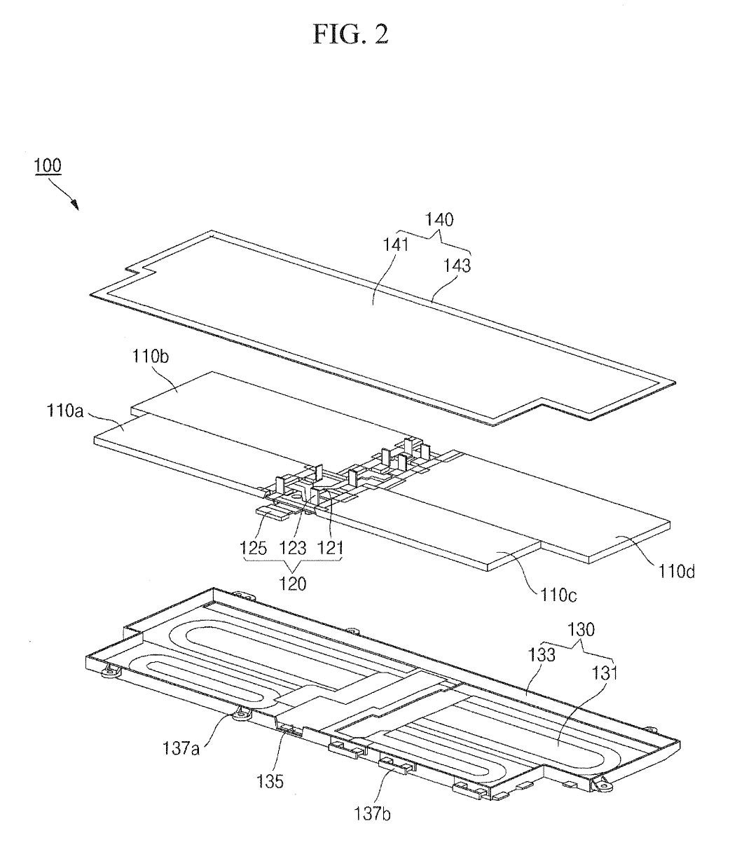

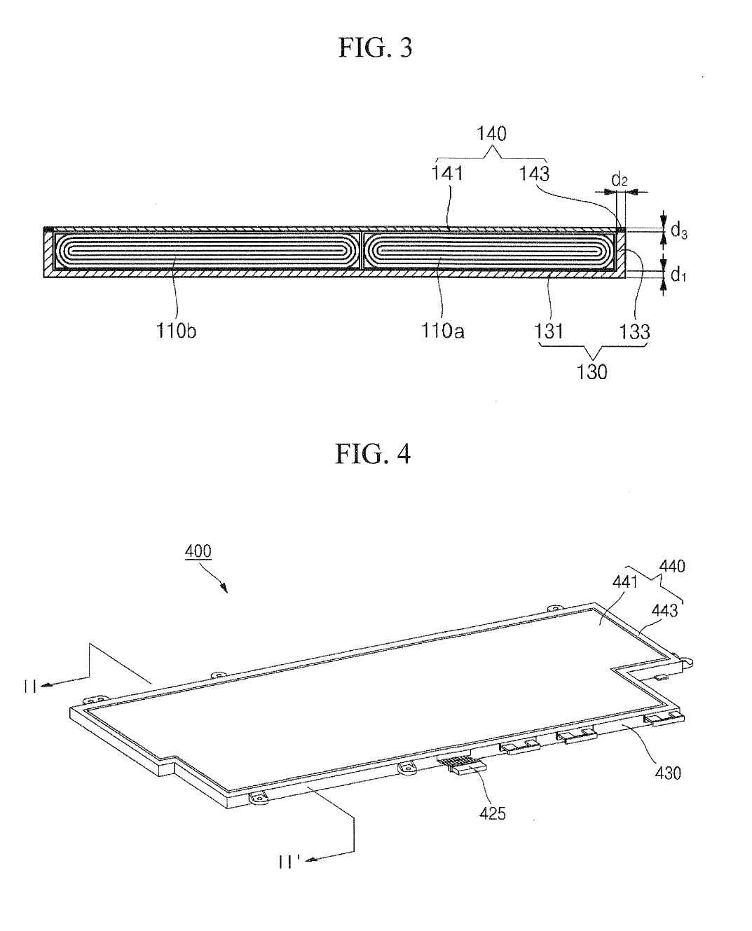

FIG. 1 is a perspective view of a battery pack according to an embodiment of the present invention, FIG. 2 is an exploded perspective view of FIG. 1 and FIG. 3 is a cross-sectional view taken along the line I-I′ of FIG. 1.

Referring to FIGS. 1 to 3, the battery pack 100 may include a plurality of batteries 110a, 110b, 110c and 110d, a protective circuit module 120, a case 130 and a cover 140.

The plurality of batteries 110a, 110b, 110c and 110d may be connected to each other in series or in parallel. The plurality of batteries 110a, 110b, 110c and 110d may be connected to each other in a combined manner of series/parallel connections such that some of the plurality of batteries 110a, 110b, 110c and 110d are connected in parallel and the others are connected in series. While FIG. 2 illustrates four batteries 110a, 110b, 110c and 110d, various numbers of batteries may constitute the battery pack 100 according to the specification of the battery pack 100. In addition, while FIG. 2 illustrates the four batteries 110a, 110b, 110c and 110d are arranged in a horizontal direction, the batteries 110a, 110b, 110c and 110d may also be arranged in a vertical direction. As described above, the present invention does not limit the number and battery arrangement manner, and many variations may be made in the number and battery arrangement manner.

Each of the batteries 110a, 110b, 110c and 110d may be, but not limited to, a rechargeable pouch-type battery, and various shapes and types of battery can be employed. In addition, each of the batteries 110a, 110b, 110c and 110d may further include an electrode tab to be electrically connected to the protective circuit module 120. The electrode tab may include a positive electrode tab and a negative electrode tab. Further, each of the batteries 110a, 110b, 110c and 110d may be implemented as a lithium-ion battery, but not limited thereto. Each of the batteries 110a, 110b, 110c and 110d may also be implemented as a nickel-cadmium battery, a nickel metal hydride battery (NiMH), or the like.

The protective circuit module 120 may include a protection circuit board 121, a plurality of connection tabs 123 and an external input/output terminal 125.

The protection circuit board 121 may be electrically connected to the plurality of batteries 110a, 110b, 110c and 110d. For example, in a state in which the respective electrode tabs of the plurality of batteries 110a, 110b, 110c and 110d are brought into contact with the protection circuit board 121, the connection tabs 123 formed in the protection circuit board 121 are bent to cover the electrode tabs and then soldered, thereby electrically connecting the protection circuit board 121 to the plurality of batteries 110a, 110b, 110c and 110d.

The protection circuit board 121 may include an electric device (not shown) and a circuit pattern layer (not shown). The electric device (not shown) may collect state information, such as charged states or temperatures of the plurality of batteries 110a, 110b, 110c and 110d to the control charge/discharge operations of the plurality of batteries 110a, 110b, 110c and 110d.

The external input/output terminal 125 may be electrically connected to the protection circuit board 121 and a portion thereof may be exposed to the outside of the case 130. The external input/output terminal 125 may be configured to perform data communication with an external circuit (not shown) or to receive power from an external power supply device (not shown) or to supply power to an external load (not shown).

FIG. 2 illustrates each two of the plurality of batteries 110a, 110b, 110c and 110d are horizontally arranged at opposite sides of the protective circuit module 120, which is, however, provided only for illustration, but aspects of the present invention are not limited thereto. Arrangement manners of the plurality of batteries 110a, 110b, 110c and 110d and the protective circuit module 120 may be changed in various manners according to the design of the battery pack.

The case 130 may include a bottom portion 131 and a sidewall portion 133 and may provide a space to accommodate the plurality of batteries 110a, 110b, 110c and 110d and the protective circuit module 120.

The bottom portion 131 may be shaped of a substantially planar plate to allow the plurality of batteries 110a, 110b, 110c and 110d and the protective circuit module 120 to be mounted therein. In addition, a plane shape of the bottom portion 131 may be basically rectangular. However, as shown in FIG. 2, the plane shape of the bottom portion 131 may be polygonal according to the design of the pack or the arrangement manner of the plurality of batteries 110a, 110b, 110c and 110d and the protective circuit module 120.

The bottom portion 131 may have a thickness d1 of 0.6 to 0.8 mm to form a thin film. If the bottom portion 131 has the thickness d1, a wider internal space of the case 130 can be secured, thereby increasing the battery capacity. That is to say, the overall thickness of the case 130 can be reduced and the volume of the batteries 110a, 110b, 110c and 110d can be increased as much as the thickness reduced, thereby increasing the capacity of the battery pack 100.

The sidewall portion 133 may be connected to an end of the bottom portion 131 to surround the plurality of batteries 110a, 110b, 110c and 110d mounted on the bottom portion 131 and the side portion of the protective circuit module 120. The sidewall portion 133 may include a terminal opening 135 and the external input/output terminal 125 of the protective circuit module 120 may be exposed to the outside of the case 130 through the terminal opening 135.

In addition, pack connection parts 137a and 137b may be formed on outer walls of the sidewall portion 133. When the battery pack 100 is built in a mobile electronic device, such as a notebook computer or a tablet personal computer (PC), it is necessary for the battery pack 100 to be coupled and fixed to the inside of the electronic device. The pack connection parts 137a and 137b allow the battery pack 100 to be coupled and fixed to the inside of the electronic device. Structures having various shapes can be used as the pack connection parts 137a and 137b. For example, the pack connection parts 137a and 137b may be shaped of hooks or protrusions.

The sidewall portion 133 may have a sufficiently large thickness to facilitate welding of the cover 140. However, in consideration of the space where the pack connection parts 137a and 137b are formed, the sidewall portion 133 may have a thickness d2 of approximately 0.6 to 1 mm. Even if the sidewall portion 133 has a small thickness, that is, the thickness d2, since the cover 140 also has a very small thickness d3, the cover 140 and the sidewall portion 133 are welded to each other with a sufficiently strong coupling force and the space for forming the pack connection parts 137a and 137b can be secured. If the pack connection parts 137a and 137b are not separately provided in the sidewall portion 133, the sidewall portion 133 may have a thickness of approximately 3 mm to facilitate welding with the cover 140.

A width of the sidewall portion 133 may vary according to the specification or design of the pack and is generally in a range of 6.5 to 7 mm. Here, the width of the sidewall portion 133 may mean a length ranging from a bottom end of the sidewall portion 133 connected to the bottom portion 131 of the case 130 to a top end of the sidewall portion 133 connected to the cover 140.

The case 130 may include polycarbonate (PC) or polycarbonate/acronitrile-butadiene-styrene (PC/ABS).

The cover 140 may be shaped of a film having a thickness d3 of approximately 0.15 to 0.25 mm and may be configured to cover a top portion of the case 130. As shown in FIG. 2, before the battery pack 100 is assembled, the case 130 has an opened top portion, and the cover 140 may cover the opened top portion of the case 130. Accordingly, the cover 140 may be shaped to correspond to a plane of the case 130.

Since the cover 140 is welded by thermal fusion or ultrasonic fusion, it should have a small thickness, so that it may include polycarbonate (PC) or polyethyleneterephthalate (PET).

After the plurality of batteries 110a, 110b, 110c and 110d and the protective circuit module 120 are mounted in the case 130, the cover 140 may be welded to the case 130 by thermal fusion or ultrasonic fusion in a state in which it covers the top portion of the case 130.

The film-shaped cover 140 may include a main plane portion 141 and an edge portion 143 formed around the main plane portion 141. Here, the edge portion 143 is a region welded to a top end of the sidewall portion 133 and may be separated from the main plane portion 141 according to presence or absence of a welded region.

One surface of the main plane portion 141 may have adhesive characteristics, and it may be adhered to surfaces of the plurality of batteries 110a, 110b, 110c and 110d when the cover 140 is welded to the case 130. For example, since an adhesive is applied to a bottom surface of the main plane portion 141, the bottom surface of the main plane portion 141 may be adhered to the surfaces of the plurality of batteries 110a, 110b, 110c and 110d when the cover 140 is welded to the case 130. Here, when the cover 140 covers the top portion of the case 130, the bottom surface of the main plane portion 141 may mean a surface facing the plurality of batteries 110a, 110b, 110c and 110d.

The edge portion 143 is a region welded to the top end of the sidewall portion 133 by thermal fusion or ultrasonic fusion. The region welded by thermal fusion is positioned on the same line with the main plane portion 141. As described above, since the cover 140 has a small thickness d3 of 0.15 to 0.25 mm, it is not necessary to separately provide welding elements, such as a welding end or a welding rib. That is to say, the cover 140 may have a portion directly welded to the case 130.

Therefore, since the thickness d3 of the cover 140, which is in a range of 0.15 to 0.25 mm, is very small, and a welding element is not separately provided in the cover 140, the overall thickness of the battery pack 100 can be reduced. In addition, since a wider internal space of the battery pack 100 formed by the case 130 and the cover 140 is secured, the capacity of battery may be increased. That is to say, the thickness of the cover 140 is eliminated from the overall thickness of the battery pack 100 and the volume of the batteries 110a, 110b, 110c and 110d can be increased by as much as the thickness is reduced, thereby increasing the overall capacity of the battery pack 100.

In addition, since the case 130 and the cover 140 are welded by thermal fusion or ultrasonic fusion, the problem of the cover 140 becoming loose can be solved.

Meanwhile, when the battery pack 100 is used as a built-in battery pack, there is little probability of the pack being damaged or broken. Therefore, the cover 140 having a very small thickness d3 of approximately 0.15 to 0.25 mm may be employed. As described above, the battery pack 100 may be used as a built-in power supply of an electronic device, such as a notebook computer, a mini notebook computer, a net-book, a mobile computer, an ultra mobile personal computer (UMPC), a tablet PC, or a portable multimedia player (PMP).

Next, a battery pack according to another embodiment of the present invention will be described with reference to FIGS. 4 to 6.

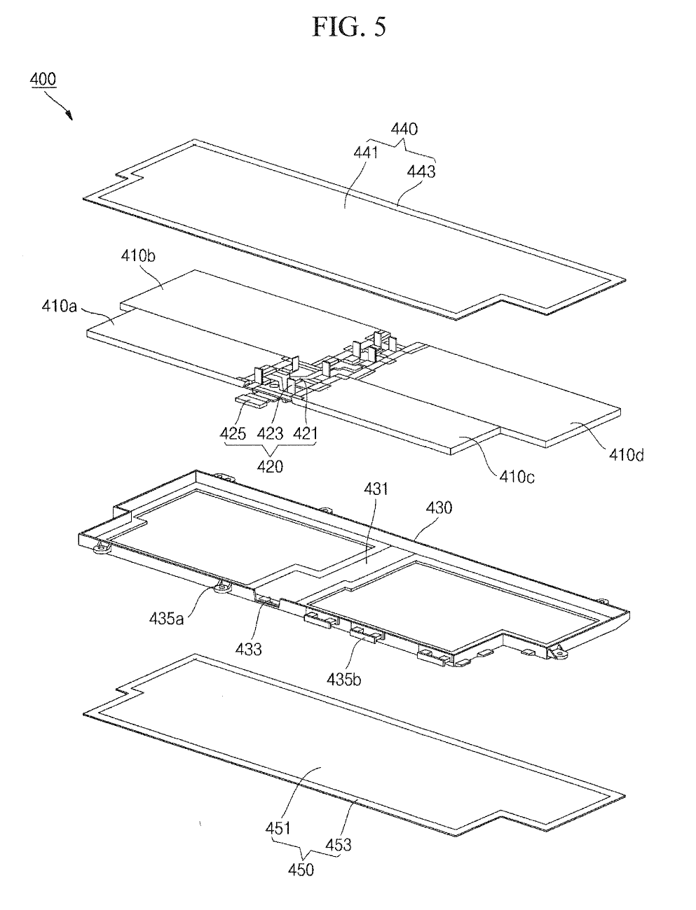

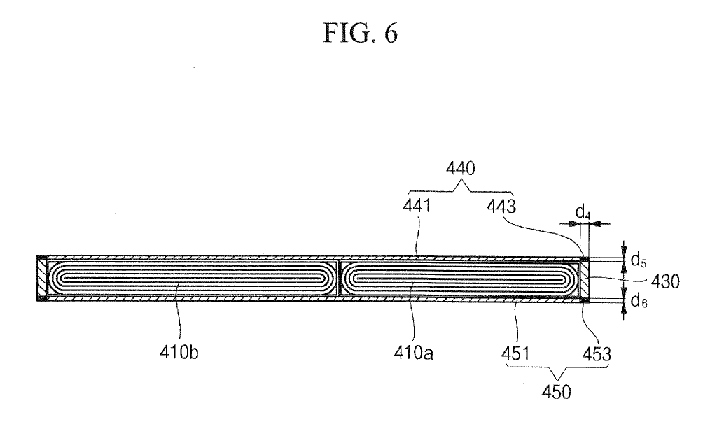

FIG. 4 is a perspective view of a battery pack according to another embodiment of the present invention, FIG. 5 is an exploded perspective view of FIG. 4, and FIG. 6 is a cross-sectional view taken along the line II-II′ of FIG. 4.

Referring to FIGS. 4 to 6, the battery pack 400 according to another embodiment of the present invention may include a plurality of batteries 410a, 410b, 410c and 410d, protective circuit module 420, a frame 430, a first cover 440 and a second cover 450.

The plurality of batteries 410a, 410b, 410c and 410d may be connected to each other in series or in parallel. The plurality of batteries 410a, 410b, 410c and 410d may be connected to each other in a combined manner of series/parallel connections such that some of the plurality of batteries 410a, 410b, 410c and 410d may be connected in parallel and the others may be connected in series. While FIG. 5 illustrates four batteries 410a, 410b, 410c and 410d, various numbers of batteries may constitute the battery pack 400 according to the specification of the battery pack 400. In addition, while FIG. 5 illustrates the four batteries 410a, 410b, 410c and 410d may be arranged in a horizontal direction, the batteries 410a, 410b, 410c and 410d may also be arranged in a vertical direction. As described above, the present invention does not limit the number and battery arrangement manner, and many variations may be made in the number and battery arrangement manner.

Each of the batteries 410a, 410b, 410c and 410d may be, but not limited to, a rechargeable pouch-type battery, and various shapes and types of battery may be employed. In addition, each of the batteries 410a, 410b, 410c and 410d may further include an electrode tab to be electrically connected to the protective circuit module 420.

The electrode tab may include a positive electrode tab and a negative electrode tab. Further, each of the batteries 410a, 410b, 410c and 410d may be implemented as a lithium-ion battery, but not limited thereto. Each of the batteries 410a, 410b, 410c and 410d may also be implemented as a nickel-cadmium battery, a nickel metal hydride battery (NiMH), or the like.

The protective circuit module 420 may include a protection circuit board 421, a plurality of connection tabs 423 and an external input/output terminal 425.

The protection circuit board 421 may be electrically connected to the plurality of batteries 410a, 410b, 410c and 410d. For example, in a state in which the respective electrode tabs of the plurality of batteries 410a, 410b, 410c and 410d are brought into contact with the protection circuit board 421, the connection tabs 423 formed in the protection circuit board 421 are bent to cover the electrode tabs and then soldered, thereby electrically connecting the protection circuit board 421 to the plurality of batteries 410a, 410b, 410c and 410d.

The protection circuit board 421 may include an electric device (not shown) and a circuit pattern layer (not shown). The electric device (not shown) may collect state information, such as charged states or temperatures of the plurality of batteries 410a, 410b, 410c and 410d to the control charge/discharge operations of the plurality of batteries 410a, 410b, 410c and 410d.

The external input/output terminal 425 may be electrically connected to the protection circuit board 421 and a portion thereof is exposed to the outside of the case 430. The external input/output terminal 425 may be configured to perform data communication with an external circuit (not shown) or to receive power from an external power supply device (not shown) or to supply power to an external load (not shown).

FIG. 5 illustrates each two of the plurality of batteries 410a, 410b, 410c and 410d are horizontally arranged at opposite sides of the protective circuit module 420, which is, however, provided only for illustration, but aspects of the present invention are not limited thereto. Arrangement manners of the plurality of batteries 410a, 410b, 410c and 410d and the protective circuit module 420 may be changed in various manners according to the design of the battery pack.

The frame 430 may surround the plurality of batteries 410a, 410b, 410c and 410d and the side portion of the protective circuit module 420. A plane shape of the frame 430 may be basically rectangular. However, as shown in FIG. 5, the plane shape of the frame 430 may be polygonal according to the design of the pack or the arrangement manner of the plurality of batteries 410a, 410b, 410c and 410d and the protective circuit module 420.

The frame 430 may include a terminal opening 433 and the external input/output terminal 425 of the protective circuit module 420 may be exposed to the outside of the case 430 through the terminal opening 433. In addition, pack connection parts 435a and 435b may be formed on outer walls of the sidewall portion 133. When the battery pack 400 is built in a mobile electronic device, such as a notebook computer or a tablet personal computer (PC), it is necessary for the battery pack 400 to be coupled and fixed to the inside of the electronic device. The pack connection parts 435a and 435b allow the battery pack 400 to be coupled and fixed to the inside of the electronic device. Structures having various shapes can be used as the pack connection parts 435a and 435b. For example, the pack connection parts 435a and 435b may be shaped of hooks or protrusions.

The frame 430 may have a sufficiently large thickness to facilitate welding of the first and second covers 440 and 450. However, in consideration of the space where the pack connection parts 435a and 435b are formed, the sidewall portion 433 may have a thickness d4 of approximately 0.6 to 1 mm. Even if the frame 430 has a small thickness, that is, the thickness d4, since each of the first and second covers 440 and 450 also has a very small thickness, the first and second covers 440 and 450 and the frame 430 are welded to each other with a sufficiently strong coupling force and the space for forming the pack connection parts 435a and 435b can be secured. If the pack connection parts 435a and 435b are not separately provided in the frame 430, the frame 430 may have a thickness of approximately 3 mm to facilitate welding with the first and second covers 440 and 450.

A width of the frame 430 may vary according to the specification or design of the pack and is generally in a range of 6.5 to 7 mm. Here, the width of the frame 430 may mean a length ranging from a top end to a bottom end of the frame 430.

A circuit mounting portion 431 connecting facing sidewalls and forming a predetermined area may be formed at the center of the frame 430. The circuit mounting portion 431 may allow the protective circuit module 420 to be mounted thereon.

Meanwhile, a stepped portion protruding toward the inside of the frame 430 may be formed at a portion of the top end or the bottom end of the frame 430. The batteries 410a, 410b, 410c and 410d may extend over the stepped portion to then be mounted on the frame 430.

The frame 430 may include polycarbonate (PC) or polycarbonate/acronitrile-butadiene-styrene (PC/ABS).

The first and second covers 440 and 450 may be shaped of films having thicknesses d5 and d6 of approximately 0.15 to 0.25 mm and may be configured to cover top and bottom portions of the frame 430. As shown in FIG. 5, before the battery pack 400 is assembled, the frame 430 has opened top and bottom portions, so that the first cover 440 may cover the opened top portion of the frame 430 and the second cover 450 may cover the opened. Accordingly, the first and second covers 440 and 450 may be shaped to correspond to a plane of the frame 430.

Since the first and second covers 440 and 450 are welded by thermal fusion or ultrasonic fusion, they should have small thicknesses, so that they may include polycarbonate (PC) or polyethyleneterephthalate (PET).

The film-shaped first cover 440 may include a first main plane portion 441 and a first edge portion 443 formed around the first main plane portion 441. Here, the first edge portion 443 is a region welded to a top end of the frame 430 and may be separated from the first main plane portion 441 according to presence or absence of a welded region.

The second cover 450 may include a second main plane portion 451 and a second edge portion 453 formed around the second main plane portion 451. Here, the second edge portion 453 is a region welded to a bottom end of the frame 430 and may be separated from the second main plane portion 451 according to presence or absence of a welded region.

The battery pack 400 may be assembled in the following manner, which will now be briefly described. First, the second cover 450 may be positioned such that the second edge portion 453 of the second cover 450 is brought into contact with the bottom end of the frame 430, and the second edge portion 453 may be welded to the bottom end of the frame 430 by thermal fusion or ultrasonic fusion. Next, the plurality of batteries 410a, 410b, 410c and 410d and the protective circuit module 420 may be placed inside the frame 430, and the first cover 440 may be welded to the top end of the frame 430 by thermal fusion or ultrasonic fusion.

One surface of each of the first and second main plane portions 441 and 451 may have adhesiveness, and it may be adhered to surfaces of the plurality of batteries 410a, 410b, 410c and 410d when the first and second covers 440 and 450 are welded to the frame 430. For example, since an adhesive is applied to a bottom surface of each of the first and second main plane portions 441 and 451, the bottom surfaces of the first and second main plane portions 441 and 451 may be adhered to the surfaces of the plurality of batteries 410a, 410b, 410c and 410d when the first and second covers 440 and 450 are welded to the frame 430. Here, when the first and second covers 440 and 450 cover the top and bottom portions of the frame 430, respectively, the bottom surfaces of the first and second main plane portions 441 and 451 may mean surfaces facing the plurality of batteries 110a, 110b, 110c and 110d.

The first and second edge portions 443 and 453 are regions welded to the top and bottom ends of the frame 430 by thermal fusion or ultrasonic fusion. The welded regions are positioned in the same lines with the first and second main plane portions 441 and 451. That is to say, the region of the first edge portion 443 welded by thermal fusion is positioned on the same line with the first main plane portion 441, and the region of the second edge portion 453 welded by thermal fusion is positioned on the same line with the second main plane portion 451. As described above, since the first and second covers 440 and 450 have small thicknesses d5 and d6 of 0.15 to 0.25 mm, it is not necessary to separately provide welding elements, such as a welding end or a welding rib. That is to say, the first and second covers 440 and 450 may have portions directly welded to the frame 430.

Therefore, since the thicknesses d5 and d6 of the first and second covers 440 and 450, which are in a range of 0.15 to 0.25 mm, are very small, and welding elements are not separately provided in the first and second covers 440 and 450, the overall thickness of the battery pack 400 can be reduced. In addition, since a wider internal space of the battery pack 400 formed by the frame 430 and the first and second covers 440 and 450 is secured, the capacity of battery may be increased. That is to say, the thicknesses of the first and second covers 440 and 450 are eliminated from the overall thickness of the battery pack 400 and the volume of the batteries 410a, 410b, 410c and 410d can be increased as much as the thicknesses reduced, thereby increasing the overall capacity of the battery pack 400.

In addition, since the frame 430 and the first and second covers 440 and 450 are welded by thermal fusion or ultrasonic fusion, the problem of the first and second covers 440 and 450 getting loose can be solved.

Meanwhile, when the battery pack 400 is used as a built-in battery pack, there is little probability of the pack being damaged or broken. Therefore, the first and second covers 440 and 450 having very small thicknesses d5 and d6 of approximately 0.15 to 0.25 mm may be employed. As described above, the battery pack 400 may be used as a built-in power supply of an electronic device, such as a notebook computer, a mini notebook computer, a net-book, a mobile computer, an ultra mobile personal computer (UMPC), a tablet PC, or a portable multimedia player (PMP).

While the battery pack of the invention has been described in connection with what is presently considered to be practical exemplary embodiments, it is to be understood that the invention is not limited to the disclosed embodiments, but, rather is intended to cover various modifications and equivalent arrangements included within the spirit and scope of the appended claims.

What is claimed is:

1. A battery pack, comprising:
at least one battery;
a protective circuit module electrically connected to the battery;
a case accommodating the battery and the protective circuit module; and
a film-shaped cover covering the case,
wherein an edge portion of the cover is welded to a top end of the case.

2. The battery pack of claim 1, wherein the cover includes a main plane portion and the edge portion formed around the main plane portion, and the main plane portion is adhered to a surface of the battery using an adhesive.

3. The battery pack of claim 1, wherein the cover includes a main plane portion and the edge portion formed around the main plane portion, and a welded region of the edge portion is positioned on the same line with the main plane portion.

4. The battery pack of claim 1, wherein the case includes polycarbonate (PC) or polycarbonate/acronitrile-butadiene-styrene (PC/ABS).

5. The battery pack of claim 1, wherein the cover includes polycarbonate (PC) or polyethyleneterephthalate (PET).

6. The battery pack of claim 1, wherein the cover has a thickness of 0.15 to 0.25 mm.

7. The battery pack of claim 1, wherein the case includes a bottom portion on which the battery and the protective circuit module are mounted and a sidewall portion surrounding the battery and the protective circuit module, and the bottom portion has a thickness of 0.6 to 0.8 mm.

8. The battery pack of claim 1, wherein the battery pack is a built-in battery pack.

9. A battery pack, comprising:
at least one battery;
a protective circuit module electrically connected to the battery;
a frame surrounding the battery and a side portion of the protective circuit module;
a film-shaped first cover covering a top portion of the frame; and
a film-shaped second cover covering a lower portion of the frame,
wherein an edge portion of the first cover is welded to a top end of the frame and an edge portion of the second cover is welded to a bottom end of the frame.

10. The battery pack of claim 9, wherein the first cover includes a first main plane portion and a first edge portion formed around the first main plane portion, the second cover includes a second main plane portion and a second edge portion formed around the second main plane portion, and the first main plane portion and the second main plane portion are adhered to a surface of the battery using an adhesive, respectively.

11. The battery pack of claim 9, wherein the first cover includes a first main plane portion and a first edge portion formed around the first main plane portion, the second cover includes a second main plane portion and a second edge portion formed around the second main plane portion, a welded region of the first edge portion is positioned on the same line with the first main plane portion, and a welded region of the second edge portion is positioned on the same line with the second main plane portion.

12. The battery pack of claim 9, wherein the frame includes polycarbonate (PC) or polycarbonate/acronitrile-butadiene-styrene (PC/ABS).

13. The battery pack of claim 9, wherein the first cover and the second cover include polycarbonate (PC) or polyethyleneterephthalate (PET).

14. The battery pack of claim 9, wherein each of the first and second covers has a thickness of 0.15 to 0.25 mm.

15. The battery pack of claim 9, wherein the battery pack is a built-in battery pack.
